(19) United States
(12) Patent Application Publication
(10) Pub. No.: US 2012/0308889 A1
(43) Pub. Date: Dec. 6, 2012

(54) NEGATIVE ELECTRODE AND RECHARGEABLE LITHIUM BATTERY INCLUDING SAME

(75) Inventor: Byung-Joo Chung, Yongin-si (KR)

(73) Assignee: Samsung SDI Co., Ltd., Yongin-si (KR)

(21) Appl. No.: 13/363,302

(22) Filed: Jan. 31, 2012

(30) Foreign Application Priority Data
Jun. 3, 2011 (KR) 10-2011-0053956

(51) Int. Cl. H01M 4/134; H01M 4/38; H01M 4/62; H01M 10/05; B82Y 30/00

(52) U.S. Cl. 429/217; 977/773

(57) ABSTRACT

Disclosed are a negative electrode including a shape memory polymer represented by the following Chemical Formula 1 and having a weight average molecular weight ranging from 5,000 to 300,000 and a rechargeable lithium battery including the negative electrode:

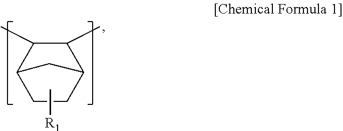

where R₁ is defined in the specification.

### CLAIM OF PRIORITY

This application makes reference to, incorporates the same herein, and claims all benefits accruing under 35 U.S.C. §119 from an application earlier filed in the Korean Intellectual Property Office on 3 Jun. 2011 and there duly assigned Serial No. 10-2011-0053956.

### BACKGROUND OF THE INVENTION

1. Field of the Invention

An embodiment of the present invention relates to a negative electrode and a rechargeable lithium battery including the same, and more particularly, to a negative electrode being capable of improving capacity and cycle-life of a rechargeable lithium battery and a rechargeable lithium battery including the negative electrode.

2. Description of the Related Art

Since portable electronics and communication devices, such as a video camera, a cellular phone, a laptop, and the like, tend to have smaller size and lighter weight, a battery used as a power source for these devices is required to have higher energy density as well as smaller size and lighter weight.

A rechargeable lithium battery including an organic electrolyte solution has twice or even more discharge voltage in comparison with a rechargeable lithium battery including a conventional alkali aqueous solution. The rechargeable lithium battery including the organic electrolyte solution therefore has higher energy density in comparison with the rechargeable lithium battery including the conventional alkali aqueous solution. Accordingly, a rechargeable lithium battery including an organic electrolyte solution has an advantage of being smaller in size and lighter in weight and has higher capacity of charge and discharge. A rechargeable lithium battery may include a carbon-based material as a negative active material which is the main component consisting of a negative electrode.

The carbon-based material however has a limited capacity of charge and discharge and thus has a limited range of applications. Accordingly, an alternative negative active material has been researched to satisfy the recently increasing requirement of a rechargeable lithium battery with higher capacity of charge and discharge. For example, a lithium metal has higher energy density; however, the lithium metal has problems of safety and shorter cycle-life due to growth of a dentrite phase during the repetitive charges and discharges.

In addition, a lithium alloy having higher capacity of charge and discharge and replacing the lithium metal has been actively researched. For example, silicon (Si) has a maximum theoretical capacity of 4000 mAh/g when Si reacts with lithium. Accordingly, a Si-based material has much bigger theoretical capacity than a carbon-based material; therefore, the Si-based material is very promising to be used as the negative active material of the battery.

However, since Si may crack due to volume change during the charge and discharge of the battery, such crack may cause Si active material particles to be destroyed. Accordingly, the Si active material may significantly deteriorate the battery's capacity of charge and discharge, because the cycles of charge and discharge of the battery may increase, and the Si active material may resultantly deteriorate cycle-life of a battery.

### SUMMARY OF THE INVENTION

An aspect of the present invention provides a negative electrode being capable of improving capacity and cycle-life characteristics of a rechargeable lithium battery.

Another aspect of the present invention provides a rechargeable lithium battery having improved capacity and cycle-life characteristics.

One embodiment of the present invention provides a negative electrode for a rechargeable lithium battery. The negative electrode for a rechargeable lithium battery may include a silicon-based active material including a silicon-based material or the silicon-based material coated with conductive carbon on the surface, a polynorbornene shape memory polymer represented by the following Chemical Formula 1 and having a weight average molecular weight ranging from 5,000 to 300,000, and a conductive material.

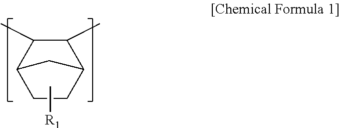

In the above Chemical Formula 1, R₁ may be selected from hydrogen, a substituted or unsubstituted C1 to C15 alkyl group, a carboxylic acid ester group (—COOR₂), a silyl group (—SiR₄R₅R₆), an alkoxysilyl group —Si(OR₇)(OR₈)(OR₉), and a siloxyl group (—OSi(R₁₀)(R₁₁)(R₁₂),

R₂ to R₁₂ may be independently either the same as or different from each other, and may be selected from a substituted or unsubstituted C1 to C15 alkyl group, a substituted or unsubstituted C3 to C15 cycloalkyl group, a substituted or unsubstituted C3 to C15 heterocycloalkyl group, a substituted or unsubstituted C6 to C20 aryl group, and a substituted or unsubstituted C2 to C20 heteroaryl group.

The shape memory polymer may have an average particle diameter of 20 nm to 50 μm.

The silicon-based material may include at least one selected from Si, SiOₓ (0<x<2), a Si—Z alloy (wherein, Z is an element selected from an alkali metal, an alkaline-earth metal, a transition element, a group 13 element, a group 14 element, a 15 element, a rare earth element, and a combination thereof), and a combination thereof.

Z may be selected from Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, Sb, and a combination thereof.

The conductive material may include at least one selected from natural graphite, artificial graphite, carbon black, acetylene black, ketjen black, and a carbon fiber.

The shape memory polymer may be included in a weight ranging from 5 wt % to 200 wt % based on the silicon-based active material.

The conductive material may also be included in a weight ranging from 5 wt % to 200 wt % based on the silicon-based active material.

Another embodiment of the present invention provides a rechargeable lithium battery that includes the negative electrode, a positive electrode including a positive active material, and a non-aqueous electrolyte.

The negative electrode includes a silicon-based active material that may increase capacity and a shape memory polymer and thus, may improve cycle-life characteristic of a rechargeable lithium battery.

Hereinafter, further embodiments of the present invention will be described in detail.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is the schematic view of a rechargeable lithium battery constructed with one embodiment of the present invention.

### DETAILED DESCRIPTION OF THE INVENTION

Embodiments will hereinafter be described in further detail with reference to the accompanying drawings, in which various embodiments are shown. This disclosure may, however, be embodied in many different forms and should not be construed as limited to the embodiments set forth herein.

These embodiments are provided to clearly illustrate the present invention to those whom have common knowledge in a related art and defined by the scope of claims. Accordingly, well-known technologies are not specifically illustrated to avoid ambiguous interpretation of the present invention in some embodiments.

Unless other definition is provided, all the terms mentioned in the specification (including technological and scientific terms) are easily understood to those who have common knowledge in a field related to the present invention. In addition, unless explicitly described to the contrary, the word “comprise” and variations such as “comprises” or “comprising,” will be understood to imply the inclusion of stated elements but not the exclusion of any other elements. Furthermore, a singular form covers a pleural form, unless specifically mentioned.

As used herein, when a definition is not otherwise provided, the term “substituted” may refer to one substituted with a substituent selected from the group consisting of a C1 to C12 alkyl group, a C1 to C15 alkoxy group, a carboxyl group, a C2 to C15 alkenyl group, a C2 to C15 alkynyl group, a C3 to C15 cycloalkyl group, a C3 to C15 cycloalkenyl group, a C3 to C15 cycloalkynyl group, a C3 to C15 heterocycloalkyl group, a C3 to C15 heterocycloalkenyl group, a C3 to C15 heterocycloalkynyl group, a C6 to C20 aryl group, and a C2 to C20 heteroaryl group. As used herein, when a definition is not otherwise provided, the prefix “hetero” may refer to a functional group including 1 to 3 heteroatoms selected from the group consisting of N, O, S, P, and Si.

The negative electrode for a rechargeable lithium battery constructed with one embodiment of the present invention includes a polynorbornene shape memory polymer represented by the following Chemical Formula 1.

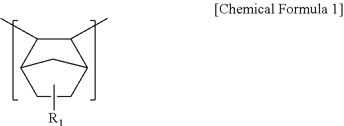

In Chemical Formula 1, R₁ is selected from the group consisting of hydrogen, a substituted or unsubstituted C1 to C15 alkyl group, a carboxylic acid ester group (—COOR₂), a silyl group (—SiR₄R₅R₆), an alkoxysilyl group —Si(OR₇)(OR₈)(OR₉), and a siloxyl group (—OSi(R₁₀)(R₁₁)(R₁₂), and

R₂ to R₁₂ are independently either the same as or different from each other, and selected from a substituted or unsubstituted C1 to C15 alkyl group, a substituted or unsubstituted C3 to C15 cycloalkyl group, a substituted or unsubstituted C3 to C15 heterocycloalkyl group, a substituted or unsubstituted C6 to C20 aryl group, and a substituted or unsubstituted C2 to C20 heteroaryl group.

Examples of the polynorbornene shape memory polymer represented by Chemical Formula 1 include polynorbornene, poly(ethyl norbornene), poly(butyl norbornene), poly(hexyl norbornene), poly(norbornene carboxylic acid methyl ester), poly(norbornene carboxylic acid n-butyl ester), poly(trimethylsilyl norbornene), poly(triethoxysilyl norbornene), poly(trimethylsiloxy norbornene), and the like.

The polynorbornene shape memory polymer represented by Chemical Formula 1 may have a weight average molecular weight of 5,000 to 300,000. When the polynorbornene shape memory polymer has a weight average molecular weight of 5,000 or more, the polynorbornene shape memory polymer may effectively control volume expansion of the silicon-based active material which will later be discussed in detail. When the polynorbornene shape memory polymer has a weight average molecular weight of 300,000 or less, negative active material slurry for a rechargeable lithium battery may be easily prepared, and such negative active material slurry may easily suppress the disadvantageous resistance increase of a substrate. The term “weight average molecular weight” ( M̅_{w}) is given to describe the molecular weight of a polymer:

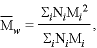

where Ni is the number of molecules which have molecular weight Mi.

In accordance with one embodiment of the present invention, a negative electrode may further include a silicon-based active material and a conductive material as well as the shape memory polymer.

The silicon-based active material may include either a silicon-based material or a silicon-based material coated with conductive carbon on the surface. The silicon-based material may include at least one selected from Si, SiOₓ (0<x<2), a Si—Z alloy (wherein, Z is selected from an alkali metal, an alkaline-earth metal, a transition element, a group 13 element, a group 14 element, a group 15 element, a rare earth element, and a combination thereof), and a combination thereof.

Non-limiting examples of Z include Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, Sb, and a combination thereof.

Silicon has theoretical capacity of 4017 mAh/g. Accordingly, silicon may accomplish high-capacity of a rechargeable lithium battery compared with a carbon-based active material which has a theoretical capacity of 380 mAh/g.

In accordance with one embodiment of the present invention, the negative electrode may further include a carbon-based active material, together with the silicon-based active material. At this time, the mixing ratio of the silicon-based active material and the carbon-based active material may be suitably controlled considering the capacity and the intended use of the battery. The carbon-based active material includes crystalline carbon, amorphous carbon, and mixtures thereof. In some embodiments, the crystalline carbon may be non-shaped, or sheet, flake, spherical, or fiber shaped natural graphite or artificial graphite. In some embodiments, the amorphous carbon may be a soft carbon, a hard carbon, mesophase pitch carbonized products, fired coke, and the like.

The conductive material may include one or more selected from the group consisting of natural graphite, artificial graphite, carbon black, acetylene black, ketjen black, and a carbon fiber.

The polynorbornene shape memory polymer represented by Chemical Formula 1 may not only be very elastic, but also may recover and maintain the original elasticity and polymer characteristics when the original conditions of the polynorbornene shape memory polymer, such as stress, temperature, or the like, are restored after the polynorbornene shape memory polymer is transformed under hazard conditions, for example, under the firing. In addition, the polynorbornene shape memory polymer may maintain a property of recovering an original structure even after being repetitively transformed and restored multiple times.

Accordingly, the polynorbornene shape memory polymer may play a role of buffering stress generated when a silicon-based active material is expanded and contracted in volume during the charge and discharge of a rechargeable lithium battery, and the polynorbornene shape memory polymer may effectively help the silicon-based active material which is expanded during the charge of the battery recover its original volume during the discharge of the battery. Therefore, the polynorbornene shape memory may improve cycle-life characteristics of a rechargeable lithium battery including the negative electrode constructed with one embodiment of the present invention.

The shape memory polymer may be controlled to have an average particle diameter ranging from 20 nm to 20 μm. The average particle diameter may be obtained by dividing the sum of the diameters of all the observed particles by the number of the observed particles. When the shape memory polymer has an average particle diameter within the range of from 20 nm to 20 μm, the shape memory polymer may be uniformly dispersed in a silicon-based active material and a conductive material, and an electrode with high density may be readily produced.

The shape memory polymer may be included in a weight ranging from 5 wt % to 200 wt % based on the weight of a silicon-based active material. When the shape memory polymer is included within the range of from 5 wt % to 200 wt %, stress due to volume change of the silicon-based active material may be efficiently removed and the original volume of the silicon-based active material may be efficiently restored.

The conductive material may be included in a weight ranging from 5 wt % to 200 wt % based on the active material. When the conductive material is included within the above identified range, a rechargeable lithium battery may be controlled to have electrochemical characteristics and energy density per weight within desired ranges.

In accordance with one embodiment of the present invention, a negative electrode is prepared by mixing a silicon-based active material, a polynorbornene shape memory polymer represented by Chemical Formula 1, and a conductive material in a solvent to prepare a negative active material composition; then coating the negative active material composition on a current collector. The mixing step may be performed by mechanically treating the resulting mixture, for example, by methods of ball-milling and the like. The polynorbornene shape memory polymer may be used as a binder. The solvent may be organic solvent such as N-methylpyrrolidone, dimethyl formamide, N,N-dimethylaminopropylamine, ethyleneoxide, tetrahydrofuran, and the like. The current collector may include a copper foil, a nickel foil, a stainless steel foil, a titanium foil, a nickel foam, a copper foam, a polymer substrate coated with a conductive metal, or a combination thereof, but is not limited thereto.

In one embodiment of the present invention, other binders besides the polynorbornene shape memory polymer may be further used. The binders may include an organic-based binder, an aqueous binder, or a combination thereof. The organic-based binder is a binder dissolved or dispersed in an organic solvent, particularly N-methylpyrrolidone (NMP), and the aqueous binder is a binder dissolved or dispersed in water as a solvent or dispersion medium. Examples of the organic-based binder may include polyvinylidene fluoride (PVDF), polyimide, polyamideimide, or a combination thereof. Examples of the aqueous binder include a rubber-based binder such as a styrene-butadiene rubber, an acrylated styrene-butadiene rubber, an acrylonitrile-butadiene rubber, an acrylic rubber, a butyl rubber, a fluorine rubber, and the like, polytetrafluoroethylene, polyethylene, polypropylene, ethylenepropylene copolymer, polyethyleneoxide, polyvinylpyrrolidone, polyepichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenol resin, an epoxy resin, polyvinylalcohol, or a combination thereof.

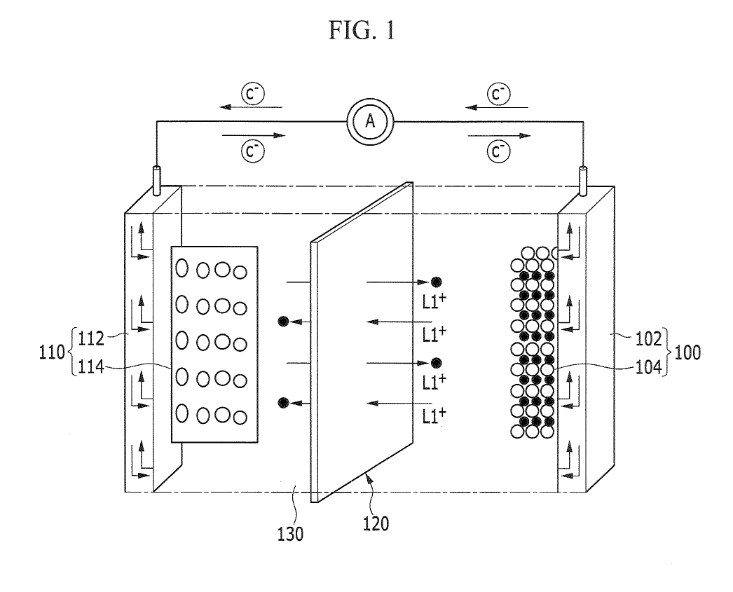

Hereinafter, referring to FIG. 1, a rechargeable lithium battery including the negative electrode constructed with one embodiment of the present invention is illustrated. FIG. 1 is a schematic view of a rechargeable lithium battery constructed with one embodiment of the present invention. Referring to FIG. 1, the rechargeable lithium battery may include a positive electrode 100, a negative electrode 110 including a negative active material layer 114, a separator 120 interposed between the positive electrode 100 and negative electrode 110, and the non-aqueous electrolyte 130 impregnated in the positive electrode 100, the negative electrode 110, and the separator 120.

The positive electrode 100 includes a current collector 102 and a positive active material layer 104 disposed on the current collector 102.

The current collector 102 includes any metal having high electrical conductivity, being easily attached to the positive active material layer 104 rechargeable lithium battery, and having no reactivity within a voltage range of a rechargeable lithium battery. For example, the current collector 102 may be formed of aluminum (Al) thin film or an aluminum alloy thin film, but is not limited thereto.

A positive active material of the positive active material layer 104 includes lithiated intercalation compounds that reversibly intercalate and deintercalate lithium ions. The positive active material may include a compound including lithium and at least one selected from the group consisting of cobalt, manganese, and nickel.

More specific examples of materials forming the compound of the positive active material are shown as follows: LiₐA_{1-b}R_{b}D₂ (0.90≦a≦1.8 and 0≦b≦0.5), LiₐE_{1-b}R_{b}O_{2-c}D_{c} (0.90≦a≦1.8, 0≦b≦0.5 and 0≦c 0.05), LiE_{2-b}R_{b}O_{4-c}D_{c} (0≦b≦0.5, 0≦c≦0.05), LiₐNi_{1-b-c}Co_{b}R_{c}D_{α} (0.90≦a≦1.8, 0≦b≦0.5, 0≦c≦0.05 and 0≦α≦2), LiₐNi_{1-b-c}Co_{b}R_{c}O_{2-α}Z_{α} (0.90≦a≦1.8, 0≦b≦0.5, 0≦c≦0.05 and 0≦a≦2), LiₐNi_{1-b-c}Co_{b}R_{c}O_{2-α}Z₂ (0.90≦a≦1.8, 0≦b≦0.5, 0≦c≦0.05 and 0<α≦2), LiₐNi_{1-b-c}Mn_{b}R_{c}D_{α} (0.90≦a≦1.8, 0≦b≦0.5, 0≦c≦0.05 and 0<α≦2), LiₐNi_{1-b-c}Mn_{b}R_{c}O_{2-α}Z_{α} (0.90≦a≦1.8, 0≦b≦0.5, 0≦c≦0.05 and 0<α<2), LiₐNi_{1-b-c}Mn_{b}R_{c}O_{2-α}Z₂ (0.90≦a≦1.8, 0≦b≦0.5, 0≦c≦0.05 and 0<a<2), LiₐNi_{b}E_{c}G_{d}O₂ (0.90≦a≦1.8, 0≦b≦0.9, 0≦c≦0.5 and 0.001≦d≦0.1), LiₐNi_{b}Co_{c}Mn_{d}GeO₂ (0.90≦a≦1.8, 0≦b≦0.9, 0≦c≦0.5, 0≦d≦0.5 and 0.001≦e≦0.1), LiₐNiG_{b}O₂ (0.90≦a≦1.8 and 0.001≦b≦0.1), LiₐCoG_{b}O₂ (0.90≦a≦1.8 and 0.001≦b≦0.1), LiₐMnG_{b}O₂ (0.90≦a≦1.8 and 0.001≦b≦0.1), LiₐMn₂G_{b}O₄ (0.90≦a≦1.8 and 0.001≦b≦0.1), QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2), and LiFePO₄.

In the above formulas, A may be Ni, Co, Mn, or a combination thereof; R may be Al, Ni, Co, Mn, Cr, Fe, Mg, Sr, V, a rare earth element, or a combination thereof; D may be O, F, S, P, or a combination thereof; E may be Co, Mn, or a combination thereof; Z may be F, S, P, or a combination thereof; G may be Al, Cr, Mn, Fe, Mg, La, Ce, Sr, V, or a combination thereof; Q may be Ti, Mo, Mn, or a combination thereof; T may be Cr, V, Fe, Sc, Y, or a combination thereof; J may be V, Cr, Mn, Co, Ni, Cu, or a combination thereof.

The compound including lithium and at least one selected from the group consisting of cobalt, manganese, and nickel, may have a coating layer on the surface, or alternatively, may be mixed with a compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxylcarbonate of a coating element. The compounds forming a coating layer may be amorphous or crystalline. The coating element for a coating layer may include Mg, Al, Co, K, Na, Ca, Si, Ti, V, Sn, Ge, Ga, B, As, Zr, or a mixture thereof. The coating layer may be formed by a method having no negative influence on properties of the positive active material by including these coating elements in the compound including lithium and at least one selected from the group consisting of cobalt, manganese, and nickel. For example, the method forming the coating layer may include any coating method such as spray coating, dipping, and the like, but is not discussed here in more detail, since such methods are well-known to those who work in the related field.

The positive active material layer 104 may also include a binder and a conductive material. The binder improves binding properties of the positive active material particles to each other and to a current collector 102. Non-limiting examples of the binder include polyvinyl alcohol, carboxylmethylcellulose, hydroxypropylcellulose, polyvinylchloride, carboxylized polyvinylchloride, polyvinylfluoride, an ethylene oxide-containing polymer, polyvinylpyrrolidone, polyurethane, polytetrafluoroethylene, polyvinylidene fluoride, polyacrylic acid, polyethylene, a polypropylene styrene-butadiene rubber, an acrylated styrene-butadiene rubber, an epoxy resin, nylon, or a combination thereof.

The conductive material is used to provide the positive electrode 100 with electrical conductivity, and may be any material except for materials which may cause a chemical change of the positive electrode 100. Examples of the conductive material for the positive electrode 100 include carbon black, acetylene black, ketjen black, a carbon fiber, a metal powder or a metal fiber of copper, nickel, aluminum, silver, and the like, a polyphenylene derivative, or a combination thereof.

The negative electrode 110 may include a current collector 112 and a negative active material layer 114 disposed on the current collector 112.

The current collector 112 includes any metal having high electrical conductivity, being easily attached to the negative active material layer 114 rechargeable lithium battery, and having no reactivity within a voltage range of a rechargeable lithium battery. For example, current collector 112 may include a copper foil, a nickel foil, a stainless steel foil, a titanium foil, a nickel foam, a copper foam, a polymer substrate coated with a conductive metal, or a combination thereof, but is not limited thereto.

The negative active material layer 114 may be formed of a negative active material constructed with the embodiments of the present invention.

The positive electrode 100 and the negative electrode 110 may be fabricated by mixing each active material, a conductive material, and a binder in a solvent to prepare an active material composition (or slurry) and then, coating the composition on each corresponding current collector 102 and 112. The solvent may include N-methylpyrrolidone, dimethyl formamide, N,N-dimethylaminopropylamine, ethyleneoxide, tetrahydrofuran, and the like but is not limited thereto. The active material composition (or slurry) may further include a thickener to adjust its viscosity. For example, the thickener may include carboxylmethyl cellulose, hydroxymethyl cellulose, hydroxyethyl cellulose, hydroxypropyl cellulose, and the like.

A separator 120 electrically separates the positive electrode 100 and the negative electrode 110 to prevent an electrical short while providing lithium ions. The separator 120 may be a single layer formed of polyethylene, polypropylene, or polyvinylidene fluoride or a multilayer formed by stocking each single layer to be more than two layers, or a mixed double layer formed of polyethylene/polypropylene and a mixed triple layer formed of polyethylene/polypropylene/polyethylene or polypropylene/polyethylene/polypropylene.

The non-aqueous electrolyte 130 includes a non-aqueous organic solvent and a lithium salt.

The non-aqueous organic solvent functions as a medium for transmitting ions taking part in the electrochemical reaction of a battery. The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like. Examples of the ketone-based solvent include cyclohexanone, and the like. Examples of the alcohol-based solvent include ethyl alcohol, isopropyl alcohol, and the like. Examples of the aprotic solvent may include nitriles, R—CN(R is a C2 to C20 linear, branched, or cyclic hydrocarbon group; an aromatic ring including a double bond; or includes an ether bond), amides such as dimethyl formamide, dioxolanes such as 1,3-dioxolane, sulfolanes, and the like.

The non-aqueous organic solvent may be used singularly or in a mixture. When the organic solvent is used in a mixture, the mixture ratio may be controlled in accordance with a desirable battery performance.

The carbonate-based solvent may include a mixture of a cyclic carbonate and a linear carbonate. The cyclic carbonate and the linear carbonate may be mixed together in the volume ratio of about 1:1 to about 1:9, and when the mixture is used as an electrolyte, the electrolyte performance may be enhanced.

In addition, the electrolyte of one embodiment of the present invention may further include mixtures of carbonate-based solvents and aromatic hydrocarbon-based solvents. The carbonate-based solvents and the aromatic hydrocarbon-based solvents are preferably mixed together in the volume ratio of about 1:1 to about 30:1.

The aromatic hydrocarbon-based organic solvent may be represented by the following Chemical Formula 2.

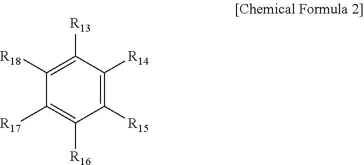

In Chemical Formula 2, R₁₃ to R₁₈ are independently hydrogen, a halogen, a C1 to C10 alkyl group, a C1 to C10 haloalkyl group, or a combination thereof.

The aromatic hydrocarbon-based organic solvent may include, but is not limited to, at least one of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate or an ethylene carbonate-based compound represented by the following Chemical Formula 3 in order to improve cycle-life of a battery.

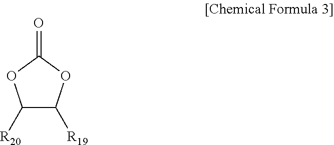

In Chemical Formula 3, R₁₉ and R₂₀ are each independently hydrogen, a halogen, a cyano group (CN), a nitro group (NO₂) or a C1 to C5 fluoroalkyl group, provided that at least either one of R₁₉ and R₂₀ is a halogen, a cyano group (CN), a nitro group (NO₂), or a C1 to C5 fluoroalkyl group.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the vinylene carbonate or the ethylene carbonate-based compound may be adjusted within an appropriate range in order to improve cycle life of the battery.

The lithium salt supplies lithium ions in the battery, operates a basic operation of a rechargeable lithium battery, and improves the transportation of lithium ions between positive and negative electrodes. Non-limiting examples of the lithium salt include at least one supporting salt selected from LiPF₆, LiBF₄, LiSbF₆, LiAsF₆, LiC4F₉SO₃, LiClO₄, LiAlO₂, LiAlO₄, LiN(CₓF₂ₓ₊₁SO₂)(C_{y}F_{2y+1}SO₂), (where x and y are natural numbers), LiCl, LiI, LiB(C₂O₄)₂ (lithium bis(oxalato) borate, LiBOB), or a combination thereof. The lithium salt may be used at a 0.1M to 2.0M concentration. When the lithium salt is included at the above concentration range, electrolyte performance and lithium ion mobility may be enhanced due to optimal electrolyte conductivity and viscosity.

Rechargeable lithium batteries may be classified as lithium ion batteries, lithium ion polymer batteries, and lithium polymer batteries according to the presence of a separator 120 and the kind of electrolyte 130 used in the battery. The rechargeable lithium batteries may have a variety of shapes and sizes, may include cylindrical, prismatic, or coin-type batteries, and may be thin film batteries or may be rather bulky in size. The structure and manufacturing method of these batteries are well-known in a related field and will not be described in detail in the specification to avoid the ambiguous interpretation of the present invention.

In a rechargeable lithium battery shown in FIG. 1, lithium ions released from the positive active material layer 104 are intercalated inside the negative active material layer 114 during the initial charge, deintercalated during the discharge, and are intercalated again inside the positive active material layer 104. In other words, lithium ions move back and forth between the positive and negative electrodes 100 and 110 and deliver energy which allows a battery to be charged and discharged.

The negative electrode 110 includes a silicon-based active material with high-capacity and thus accomplishes a high-capacity characteristic of a rechargeable lithium battery. In addition, even though the silicon-based material included in the negative active material layer 114 expands in volume when a rechargeable lithium battery is charged, another material included in the negative active material layer 114, i.e., a polynorbornene shape memory polymer represented by Chemical Formula 1, may relieve stress generated during the volume expansion of the silicon-based material. Furthermore, the polynorbornene shape memory polymer may effectively help a silicon-based active material which expands in volume by about 300% to 400% due to lithium intercalation during the charge of the battery contract itself and go back to its original volume after lithium deintercalation during the discharge of the battery. Therefore, the negative active material may improve cycle-life characteristic of a rechargeable lithium battery.

The following examples illustrate embodiments of the present invention in more detail. These examples are however not in any sense to be interpreted as limiting the scope of the present invention.

### Experimental Examples 1-5 and Comparative Experimental Examples 1-2

### Preparation of Negative Electrode

Each constituent element is mixed as provided in the following Table 1 using a planetary mixer, respectively preparing mixtures, and adding the mixtures to an N-methylpyrrolidone (NMP) solvent to prepare negative active material slurry. The slurry is coated on a copper current collector and the coated current collector is dried in a 120° C. oven and then compressed, fabricating a negative electrode, according to Experimental Examples 1 and 2 and Comparative Experimental Examples 1 to 5.

TABLE 1

| | | | Comparative | Comparative | Comparative | Comparative | Comparative |
|---|---|---|---|---|---|---|---|
| | Experimental | Experimental | Experimental | Experimental | Experimental | Experimental | Experimental |
| | Example 1 | Example 2 | Example 1 | Example 2 | Example 3 | Example 4 | Example 5 |
| Si-based | SiOₓ(x = 1) | Si(Ti, Ni) | SiOₓ(x = 1)1.6 g | Si(Ti, Ni) | SiOₓ(x = 1) | SiOₓ(x = 1) | SiOₓ(x = 1) |
| Active | 1.6 g | 1.6 g | | 1.6 g | 1.6 g | 1.6 g | 1.6 g |
| material | | | | | | | |
| Carbon-based | 6.4 g | 6.4 g | 6.4 g | 6.4 g | 6.4 g | 6.4 g | 6.4 g |
| active | | | | | | | |
| material | | | | | | | |
| Binder | Polynorbornene | Polynorbornene | styrene- | styrene- | poly | poly | poly |
| | 1 g | 1 g | butadiene | butadiene | amide | imide | vinyl |
| | | | rubber | rubber | imide | 1 g | alcohol |
| | | | 1 g | 1 g | 1 g | | 1 g |
| conductive | Carbon black | Carbon black | Carbon black | Carbon black | Carbon black | Carbon black | Carbon black |
| material | 1 g | 1 g | 1 g | 1 g | 1 g | 1 g | 1 g |
| thickner | — | — | Carboxy | Carboxy | — | — | |
| | | | methyl | methyl | | | |
| | | | cellulose | cellulose | | | |
| | | | 1 g | 1 g | | | |
| Solvent | 20 g | 20 g | 20 g | 20 g | 20 g | 20 g | 20 g |
| (NMP) | | | | | | | |

The polynorbornene has an average particle diameter of 10 μm, and a weight average molecular weight 20,000. The carbon-based active material has a size of about 10 μm, and is graphite (MC08).

Fabrication of Battery Cell

On the other hand, positive electrode slurry is prepared by adding 90 g of LiCoO₂ as a positive active material, 5 g of polyvinylidene fluoride (PVDF) as a binder, 5 g of acetylene black as a conductive material to 50 g of an NMP solvent. The positive electrode slurry is coated on an aluminum current collector. The coated current collector is dried in a 120° C. oven and then compressed, fabricating a positive electrode.

Then, non-aqueous electrolyte is prepared by dissolving LiBF₄ and LiPF₆ to have a total concentration of 1.15M in an organic solvent in an organic solvent prepared by mixing ethylene carbonate (EC): ethylmethyl carbonate (EMC): diethyl carbonate (DEC) in a volume ratio of 3:2:5.

A coin-type rechargeable lithium battery cell is fabricated by interposing a polyethylene material film as a separator between the positive and negative electrodes and then implanting the non-aqueous electrolyte therein.

Cycle-life Characteristic Evaluation

Each of coin-type rechargeable lithium battery cells respectively including the negative active material according to Experimental Examples 1 and 2 and Comparative Experimental Examples 1 to 5 is once charged and discharged at 0.1 C to perform a formation process and evaluated regarding capacity retention (cycle-life characteristic). The results are provided in the following Table 2. Then, the discharge capacity ratio of the battery cells is calculated by dividing 50^{th} cycle discharge capacity by the 1^{st} cycle discharge capacity after repetitively performing 50 cycles of charges and discharges at 1.0 C at 25° C. and measuring capacity retention (cycle-life characteristic).

TABLE 2

| | Capacity retention at |
|---|---|
| | 50^{th} cycle (%) |
| Experimental Example 1 | 91 |
| Experimental Example 2 | 87 |
| Comparative Experimental Example 1 | 77 |
| Comparative Experimental Example 2 | 72 |
| Comparative Experimental Example 3 | 65 |
| Comparative Experimental Example 4 | 81 |
| Comparative Experimental Example 5 | 39 |

Referring to Table 2, since the rechargeable lithium battery cells according to Experimental Examples 1 and 2 have higher capacity retention at the 50th cycle than the ones according to Comparative Experimental Examples 1 to 5, the rechargeable lithium battery cells including a negative active material constructed with the embodiments of the present invention has improved cycle characteristic.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative electrode for a rechargeable lithium battery, comprising:
a silicon-based active material comprising one select from a silicon-based material and the silicon-based material coated with a conductive carbon on a surface of the silicon-based material;
a polynorbornene shape-memory polymer represented by the following Chemical Formula 1, the polynorbornene shape-memory polymer having a weight average molecular weight ranging from 5,000 to 300,000; and
a conductive material, 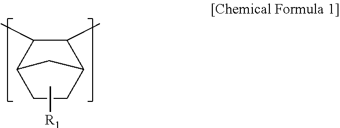
wherein, R₁ is selected from the group consisting of hydrogen, a substituted or unsubstituted C1 to C15 alkyl group, a carboxylic acid ester group(—COOR₂), a silyl group (—SiR₄R₅R₆), an alkoxysilyl group —Si(OR₇)(OR₈)(OR₉), and a siloxyl group (—OSi(R₁₀)(R₁₁)(R₁₂), and
R₂ to R₁₂ are independently the same or different, and are selected from a substituted or unsubstituted C1 to C15 alkyl group, a substituted or unsubstituted C3 to C15 cycloalkyl group, a substituted or unsubstituted C3 to C15 heterocycloalkyl group, a substituted or unsubstituted C6 to C20 aryl group, and a substituted or unsubstituted C2 to C20 heteroaryl group.

2. The negative electrode of claim 1, wherein the polynorbornene shape memory polymer has an average particle diameter of 20 nm to 50 μm.

3. The negative electrode of claim 1, wherein the silicon-based material is selected from the group consisting of Si, SiOₓ (0<x<2), a Si—Z alloy (wherein, Z is selected from an alkali metal, an alkaline-earth metal, a transition element, a group 13 element, a group 14 element, a group 15 element, a rare earth element, and a combination thereof), and a combination thereof.

4. The negative electrode of claim 3, wherein the Z is selected from the group consisting of Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, Sb, and a combination thereof.

5. The negative electrode of claim 1, wherein the conductive material comprises one or more selected from the group consisting of natural graphite, artificial graphite, carbon black, acetylene black, ketjen black, and a carbon fiber.

6. The negative electrode of claim 1, wherein the polynorbornene shape memory polymer is comprised in an amount of 5 wt % to 200 wt % based on the silicon-based active material.

7. The negative electrode of claim 1, wherein the conductive material is comprised in an amount of 5 wt % to 200 wt % based on the silicon-based active material.

8. A rechargeable lithium battery, comprising:
a negative electrode of claim 1;
a positive electrode comprising a positive active material; and
a non-aqueous electrolyte.
